(19) United States
(12) Patent Application Publication
(10) Pub. No.: US 2013/0243530 A1
(43) Pub. Date: Sep. 19, 2013

(54) Deep Trench Rod Loader Apparatus

(71) Applicants: Brian John Bischel, Bloomer, WI (US); Walter George Thompson, Janesville, WI (US)

(72) Inventors: Brian John Bischel, Bloomer, WI (US); Walter George Thompson, Janesville, WI (US)

(73) Assignee: Earth Tool Company LLC, Oconomowoc, WI (US)

(21) Appl. No.: 13/358,711

(22) Filed: Jan. 26, 2012

Related U.S. Application Data
(60) Provisional application No. 61/436,651, filed on Jan. 27, 2011.

(51) Int. Cl. F16L 1/036; E03F 3/06; B66F 11/00

(52) U.S. Cl. 405/184; 414/745.4

(57) ABSTRACT

The present invention relates to a pipe handling assembly for use with a rod pushing and pulling machine in pipe bursting and pipe replacement operations. The assembly uses a rod transport assembly to transport a rod from a vertical receiving position to a horizontal receiving position. A rod transfer assembly then axially advances the rod in a horizontal receiving position to the rod pushing and pulling machine where the rod can be incorporated into a drill string. The rod handling assembly also can be used for transporting rods out of an excavation pit after they have been broken off from a rod string by a rod pushing and pulling machine.

### CROSS REFERENCE TO RELATED APPLICATION

This application claims the benefit of provisional patent application Ser. No. 61/436,651 filed on Jan. 27, 2011, the entire contents of which are incorporated herein by reference.

### FIELD OF THE INVENTION

The present invention relates to the handling of pipe during underground pipe bursting and pipe replacement operations.

### SUMMARY OF THE INVENTION

The present invention is directed to a rod handling assembly for use with a rod pushing and pulling machine. The rod handling assembly comprises a rod transfer assembly and a rod transport assembly. The rod transfer assembly comprises a rod receiving member to transport a rod section between, a horizontal receiving position and a rod string axis defined by at least a portion of a rod string. The rod transport assembly is operatively connected to the rod transfer assembly to transport the rod section when not connected to the rod string, between a vertical receiving position and the horizontal receiving position.

The present invention is also directed to a rod pushing and pulling machine for use with a rod string comprising a series of rod sections coupled to one another end to end. The rod pushing and pulling machine comprises a housing, a drive system, and a rod handling assembly. The housing includes a front wall having an access opening therein through which the rod string extends from the housing. The drive system is supported by the housing for pushing and pulling the carriage and the rod string along the rod string axis. The rod handling assembly comprises a rod transfer assembly and a rod transport assembly. The rod transfer assembly comprises a rod receiving member to transport one of the series of rod sections between a horizontal receiving position and the rod string axis. The rod transport assembly is operatively connected to the rod transfer assembly to transport the rod section when not connected to the rod string, between a vertical receiving position and the horizontal receiving position.

The present invention is further directed to a method for adding rod sections to makeup a rod string comprised of a plurality of rod sections using a rod pushing and pulling machine with a rod string axis and a rod handling assembly. The method comprises the steps of placing a rod section in a vertical receiving position within a rod handling assembly, transporting the rod section from the vertical receiving position to a horizontal receiving position using a rod transport assembly, and axially advancing the rod from a horizontal receiving position to the rod string axis with a rod transfer assembly.

The present invention is also directed to a method for removing rod sections to breakup a rod string comprised of a plurality of rod sections, using a pushing and pulling machine with a rod string axis and a rod handling assembly. The method comprises the steps of axially retracting the rod string to position a rod section in a horizontal receiving position, disconnecting the rod section from the rod string, placing an end of the disconnected rod section in a rod transport assembly, activating the rod handling assembly to transport the rod section to a vertical receiving position, and removing the rod section from the rod handling assembly.

### BRIEF DESCRIPTION OF THE DRAWINGS

FIG. 1 is a vertical cross-section of a pipe bursting pit containing a rod handling assembly of the present invention connected to a rod pushing and pulling machine.

FIG. 2 is a right side view of the rod handling assembly of FIG. 1 with the rod section a vertical receiving position.

FIG. 3 is a side view of the rod handling assembly with the rod section in an intermediate position.

FIG. 4 is left side view of the rod handling assembly with the rod section in the horizontal receiving position.

FIG. 5 is a top view of the rod handling assembly with the rod section in the horizontal receiving position.

### DESCRIPTION OF THE PREFERRED EMBODIMENT

A current method for replacing underground pipes is to use a rod pushing and pulling machine. A rod pushing and pulling machine functions to perform pipe bursting operations to replace the existing pipe without creating an open trench along the entire length of the pipe. Pipe bursting reduces the amount of excavation required to complete the operation as compared to open trench methods; however, a small amount of excavation is still required. There is a strong desire to keep the length and width of the excavation pit minimized, as added width adds to traffic disruption and added length requires more excavation and more restoration expense. Currently, the excavation pit must be large enough to contain a rod box containing a plurality of rod sections, and be large enough for an operator to stand inside in order to feed or remove rods to and from the rod pushing and pulling machine during pipe replacement operations.

The present invention solves these problems by utilizing a rod handling assembly 12 to feed rods 30 into the rod pushing and pulling machine 14 as well as remove rods from the rod pushing and pulling machine. The rod handling assembly 12 can attach to the rod pushing and pulling machine 14 and transport rods 30 between a horizontal receiving position to a vertical receiving position. This allows the operator to stand on a platform 16 above the rod pushing and pulling machine 14 in the excavation pit 10 and feed rods 30 into the rod handling assembly 12, which the rod handling assembly can then feed into the rod pushing and pulling machine. Using the rod handling assembly 12 also allows the rod box 34 to be located on the ground surface 36 outside of the excavation pit 10 as the operator can reach both the rod box and the rod handling assembly by standing on the platform 16. Placement of the operator 20 above the rod pushing and pulling machine 14 and placement of the rod box 34 outside of the excavation pit 10 greatly reduces the size of the pit and decreases surface disruption. Additionally, safety of the operator is increased.

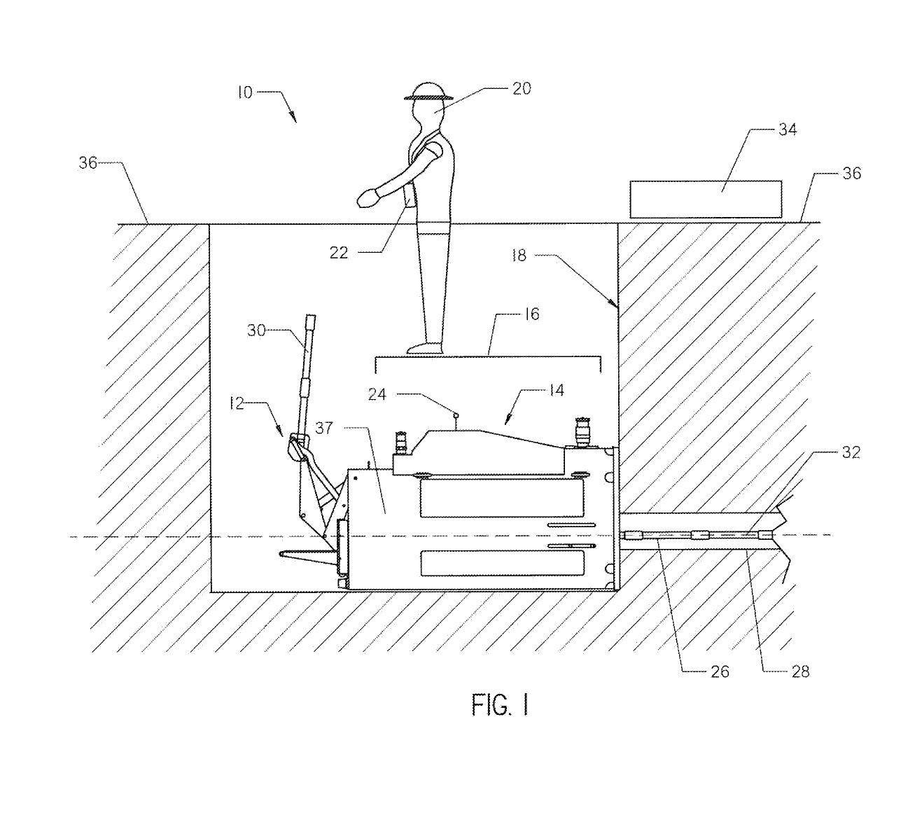

Turning now to the drawings, FIG. 1 is a cross-sectional view of the pipe bursting pit 10. A rod handling assembly 12 is shown attached to a rod pushing and pulling machine 14 within pit 10. A platform 16 may be placed above the rod pushing and pulling machine 14 within the pit 10. A preferred method of securing the platform 16 within the pit 10 is to attach the platform 16 to the side walls 18 of the pit 10 after the rod pushing and pulling machine 14 has been placed inside the pit. An operator 20 may stand on the platform 16 when operating the rod handling assembly 12. The operator 20 may operate the rod handling assembly 12 and the rod pushing and pulling machine 14 via the use of a remote control 22. A receiving antenna 24 mounted on the rod pushing and pulling machine 14 will accept RF signals from the remote control 22. The signals received by the antennae 24 will actuate the electro hydraulic valves (not shown) to control the rod pushing and pulling machine 14 and the rod handling assembly 12. In this way, there is no need for an operator 20 to move in the proximity of the pit 10.

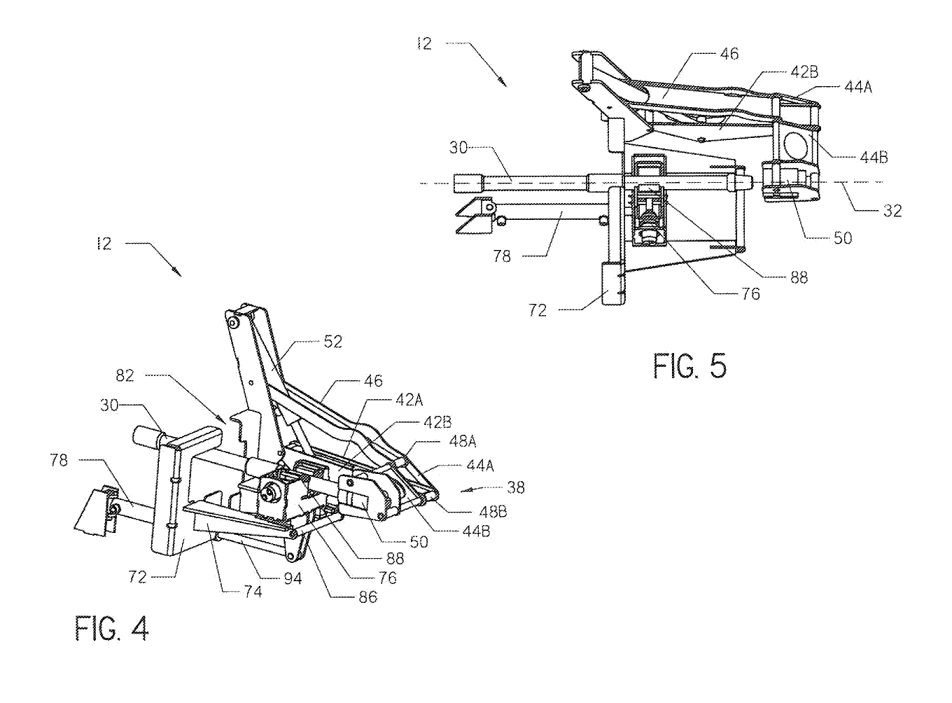

Also shown in FIG. 1 is a rod string 26 extending into a borehole 28. The rod string 26 is made from a series of rod sections 30 connected together. A rod string axis 32 runs through the center of the rod string 26. When making the rod string 26, the operator 20 may grab the rod section 30 from a rod box 34 positioned on a ground surface 36 just outside of the pit 10. The platform 16 is ideally positioned such that the operator 20 can reach the rod box 34 on the ground surface 36 while standing on the platform. Once the operator 20 selects a rod 30 from the rod box 34 he may place the rod 30 in the rod handling assembly 12 in the vertical receiving position as shown in FIG. 1; the rod handling assembly 12 then transports the rod 30 to the horizontal receiving position (as shown in FIG. 4) at the rod pushing and pulling machine 14. The rod section 30 is then connected to the rod string 26 using the rod pushing and pulling machine 14 in a process described in published United States Patent application 2007/0245516, the contents of which are incorporated herein by reference.

The rod pushing a pulling machine 14 preferably comprises a housing 37 and a drive system (not shown). The housing 37 may include a front wall having an access opening (as seen in the above referenced application) therein through which the rod string 26 extends from the housing. The rod section 30 may be transported into the rod pushing and pulling machine 14 through the access opening. The drive system, as shown in the above referenced application, is used to push and pull the rod string 26 along the rod string axis 32.

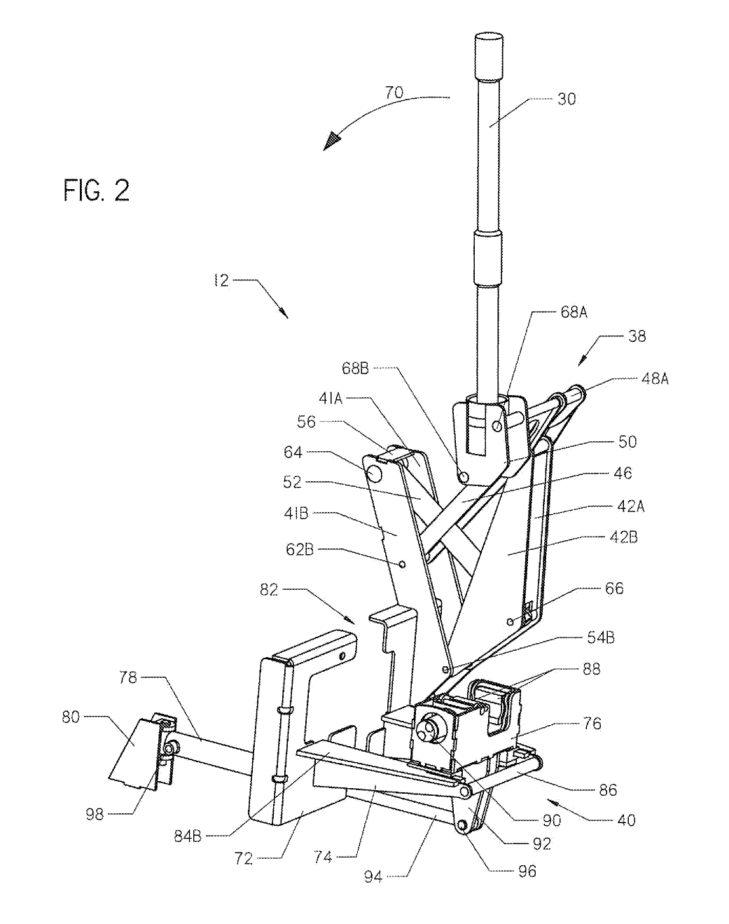

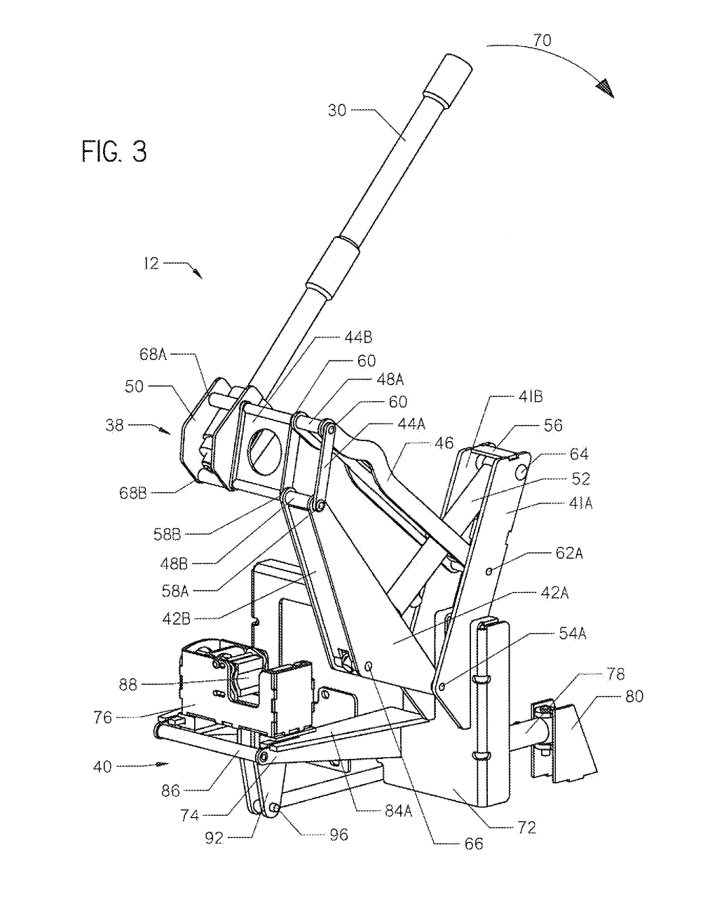

Turning now to FIGS. 2 and 3, FIG. 2 shows the rod handling assembly 12 of FIG. 1 with the rod in the vertical receiving position and FIG. 3 shows the rod handling assembly 12 with the rod 30 in an intermediate position. The rod handling assembly 12 comprises a rod transport assembly 38 connected to a rod transfer assembly 40. The rod transport assembly 38 functions to transport the rod 30 from a vertical receiving position (as shown in FIG. 2) where the rod 30 is within reach of the operator to a horizontal receiving position (as shown in FIG. 4) where the rod 30 is in position to be advanced into the rod pushing and pulling machine 14. The rod transport assembly 38 is capable of movement in the reverse in order to remove rods 30 from the rod string 26 and the rod pushing and pulling machine 14.

The rod transport assembly 38 comprises a linkage comprising a first and a second mounting brace 41a and 41b, a first and second arm 42a and 42b, a first and second pivot link 44a and 44b, a top arm 46, a top and bottom pivot pin 48a and 48b, a socket 50, and a cylinder 52.

The first mounting brace 41a connects to the first link arm 42a at a pivot point 54a. The second mounting brace 41b connects to the second arm 42b at pivot point 54b. The first and second mounting braces 41a and 41b are connected to the rod transfer assembly 40 at a mounting plate 72. The first and second mounting braces 41a and 41b remain in a stationary and vertical position during operation. A mounting brace connector 56 connects each top edge of the first and second mounting brace 41a and 41b to provide stability. The first and second arms 42a and 42b form a substantially triangular shape and move from a vertical to horizontal position during operation. The first arm 42a connects to the first pivot link 44a at the end of arm 42a opposite connection point 54a at a pivot point 58a. The second arm 42b connects to the second pivot link 44b also at the end of arm 42b opposite connection point 54b at a pivot point 58b. The first pivot link 44a is shorter in length than the first and second arms 42a and 42b and functions to allow socket 50 to pivot during operation of the assembly 38. The second pivot link 44b extends out past the edge of the second arm 42b. The first and second pivot links 44a and 44b connect to the top link arm 46 at pivot points 60. The top arm 46 forms an elongate arm connected to the first mounting brace 41a at one end at a pivot point 62a and connects to the second mounting brace 41b at the opposite end at a pivot point 62b.

Continuing with FIGS. 2 and 3, the cylinder 52 connects to the first and second mounting brace 41a and 41b at pivot point 64. The opposite end of the cylinder 52 connects to the first and second arms 42a and 42b at pivot point 66.

In operation the cylinder 52 extends and pushes the first and second arms 42a and 42b downward. Movement of the first and second arms 42a and 42b causes movement of the first and second pivot links 44a and 44b and the top arm 46 and movement of the socket 50 to the horizontal receiving position.

The socket 50 attaches to the edges of the second pivot link 44b via pins 68a and 68b. Running lengthwise between pin 68a and pivot points 60 is pivot arm 48a. Similarly, running lengthwise between pin 68b and pivot points 58 is pivot arm 48b. Activation of the arms 42a and 42b, middle links 44a and 44b, and top arm 46 causes the pivot arms 48a and 48b to rotate at pivot points 60 and 58. In operation, extension of the cylinder 52 causes the first and second arms 42a and 42b to rotate downwards from a vertical to horizontal position pulling the first and second pivot link 44a and 44b and the top 46 downwards causing the socket 50 to rotate in the direction of arrow 70 via the rotation of pivot arms 48a and 48b.

FIGS. 2 and 3 also show the rod transfer assembly 40. The rod transfer assembly 40 supports the rod transport assembly 38 and functions to transfer the rod 30, when in the horizontal receiving position (as shown in FIG. 4), to and from the rod pushing and pulling machine 14. The rod transfer assembly 40 comprises mounting plate 72, a frame 74, a rod receiving member 76, a cylinder 78, and a frame arm 80. The mounting plate 72 forms a substantially rectangular shape and is configured for mounting onto the rod pushing and pulling machine 14. The first and second mounting brace 41a and 41b connect to the mounting plate 72 adjacent the frame 74. The mounting plate 72 comprises an opening 82 to allow movement of the rod 30 between the vertical receiving position and the horizontal receiving position without threading the rod 30 through the mounting plate 72.

The frame 74 comprises a pair of guide arms 84a and 84b and a connector 86. The guide arms 84a and 84b attach to the mounting plate 72 and are connected opposite the mounting plate 72 via connector 86. The rod receiving member 76 comprises a pair of jaws 88, a cylinder 90, and a brace 92. The rod receiving member 76 is open on one side and configured for receiving and gripping the rod 30 in the horizontal receiving position without threading. The pair of jaws 88 of the rod receiving member 76 work to grip the rod 30 upon being actuated by the cylinder 90.

The rod receiving member 76 shown in FIGS. 2 and 3 is movable axially about the guide arms 84a and 84b of the frame 74. The rod receiving member 76 is capable of moving between mounting plate 72 and link 86. The cylinder 78 of the rod transfer assembly 40 comprises a rod 94. The rod attaches to the brace 92 of the rod receiving member 76 via a pin 96. The cylinder 78 functions to move the rod receiving member 76 axially between the mounting plate 72 and the link 86 of the frame 74. When the rod 30 is in the horizontal receiving position and gripped by the pair of jaws 88 of the rod receiving member 76, movement of the rod receiving member 76 axially by extension and retraction of the rod 94 within the cylinder 78 moves the rod 30 to and from the horizontal receiving position and the rod string axis 32 (as shown in FIG. 1). The cylinder 78 connects to the frame arm 80 via a pin 98. The frame arm 80 is configured for mounting onto the rod pushing and pulling device 14 to help support the cylinder 78.

Turning now to FIG. 4, the rod handling assembly 12 is shown with the rod 30 in the horizontal receiving position within the rod receiving member 76 comprising the pair of jaws 88. The rod transport assembly 38 is shown in a horizontal position with the cylinder 52 all the way extended pushing down on the first and second link arms 42a and 42b. The movement of first and second arms 42a and 42b down pulls first and second pivot link 44a and 44b as well as top arm 46 down. This downward movement causes pivot arms 48a and 48b to rotate and in turn rotates the socket 50 in the direction of arrow 70 (shown in FIG. 2). The rotation of the socket 50 causes the rod 30 to rotate from a vertical receiving position (as shown in FIG. 2) to a horizontal receiving position (as shown in FIG. 4) while at the same time being pulled downwards and placed into the rod receiving member 76.

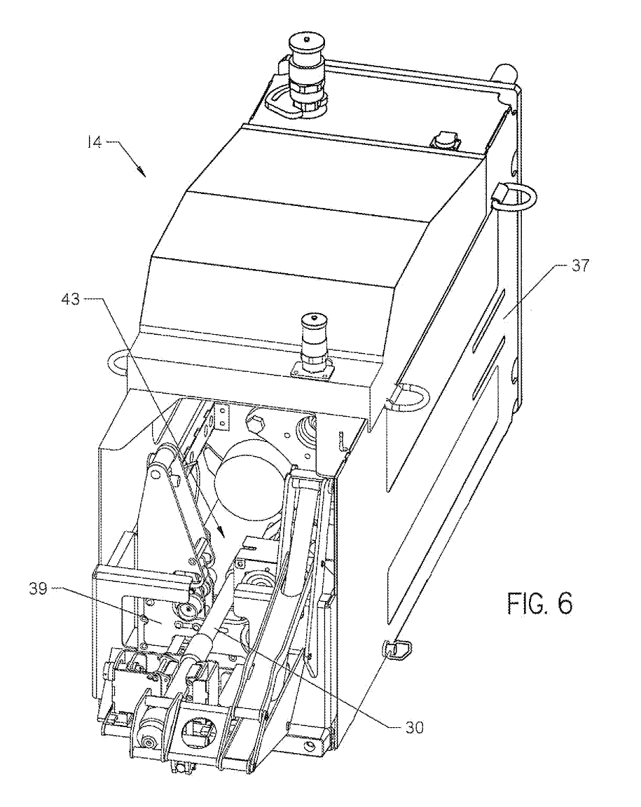

Continuing with FIG. 4, in operation, the rod 30 passes through opening 82 on the mounting plate 72 and is placed within the rod receiving member 76 without threading the rod 30 through the mounting plate 72. FIG. 4 shows the rod receiving member 76 at the back of frame 74 near connector 86 due to cylinder rod 94 being fully extended from the cylinder 78. In this position the rod 30 has not yet been axially advanced to rod pushing and pulling machine 14 in order to be connected to the rod string 26 along the rod string axis 32 (as shown in FIG. 5).

Turning to FIG. 5, a top view of the rod handling assembly 12 is shown with the rod 30 positioned at the rod string axis 32. The cylinder 78 is shown in the retracted position wherein the rod receiving member 76 has been axially advanced proximate the mounting plate 72. The pair of jaws 88 are shown gripping the rod 30. Movement of the rod receiving member 76 towards the mounting plate 72 pulls the rod 30 from the socket 50. Once pulled from the socket 50, the rod 30 is axially advanced to the rod pushing and pulling machine 14 (as shown in FIG. 1) along the rod string axis 32 in preparation for being added to the rod string 26 via the rod pushing and pulling machine 14. First and second arms 42a and 42b, first and second pivot links 44a and 44b, and top arm 46 are shown pushed downwards in a generally horizontal position in FIG. 5.

In a method of adding rod sections to makeup the rod string, the operator 20 selects a rod 30 from the rod box 34. The operator 20 then places the rod 30 within the socket 50 of the rod transport assembly 38; the rod transport assembly 38 holding the rod in the vertical receiving position. The cylinder 52 of the rod transport assembly 38 extends pushing the first and second arm 42a and 42b downwards and causes pivot arms 48a and 48b to descend and rotate socket 50. The rod section 30 is simultaneously moved downwards and rotated through opening 82 in mounting plate 72 to a horizontal receiving position and placed into the rod receiving member 76. The jaws 88 then grip the rod 30 by the activation of cylinder 90. Cylinder 78 of the rod transfer assembly 40 then retracts pulling the rod receiving member 76 axially towards mounting frame 72 and closer to the rod pushing and pulling machine 14. This action pulls the rod 30 from the socket 50 and puts the rod 30 in position to be accepted by the rod pushing and pulling machine 14 and connected to the rod string 26 along the rod string axis 32. After the rod 30 is engaged by the rod pushing and pulling machine 14, the cylinder 52 retracts pulling the first and second arms 42a and 42b upwards causing the first and second pivot links 44a and 44b and the top arm 46 to return to their vertical receiving position. The rod receiving member 76 is retracted axially backwards via extension of rod 94 and prepared for receiving another rod 30. These steps are repeated until the rod string 26 has been completed.

In a method for removing rod sections 30 to breakup the rod string 26, the rod 30 is first disconnected from the rod string 26 via the rod pushing and pulling machine 14. The rod receiving member 76 is axially advanced toward the mounting plate 72, placing it in position for receiving the rod 30 from the rod pushing and pulling machine 14. The rod receiving member 76 grips onto the rod 30 via the jaws 88 and retracts axially backwards by extension of cylinder 78. Extension of cylinder 78 places the rod 30 within socket 50. Once the rod 30 is within socket 50, the jaws 88 release the rod 30. The cylinder 52 of the rod transport assembly 38 then retracts pulling the first and second arms 42a and 42b upwards which causes the pivot arms 48a and 48b to pivot rotating the socket 50 and rod 30 upwards to a vertical receiving position. Once the socket 50 and the rod 30 are in the vertical receiving position, the operator 20 may remove the rod 30 from the socket 50 and place the rod back in the rod box 34. The rod transport assembly 38 then returns to the horizontal receiving position and the rod receiving member 76 advances axially forward in preparation for receiving another rod 30 from the rod pushing and pulling machine 14. These steps are repeated until the rod string 26 has been completely disassembled and removed from the borehole 28.

Although the present invention has been described with respect to several specific preferred embodiments thereof, various changes and modifications may be suggested to one skilled in the art, and it is intended that the present invention encompass such changes and modifications as fall within the scope of the appended claims.

1. A rod handling assembly for use with a rod pushing and pulling machine, the handling assembly comprising:
a rod transfer assembly comprising a rod receiving member, wherein the rod receiving member comprises a gripper, and transports a rod section between a horizontal receiving position and a rod string axis defined by at least a portion of a rod string, wherein the rod transfer assembly comprises a frame along which the rod receiving member is movable independent of the rod handling assembly; and
a rod transport assembly operatively connected to the rod transfer assembly to transport the rod section when not connected to the rod string; between a vertical receiving position and the horizontal receiving position.

2-3. (canceled)

4. The rod handling assembly of claim 1 wherein the gripper is open on one side to position the rod in the horizontal receiving position without threading.

5. The rod handling assembly of claim 1 wherein the rod transport assembly comprises a socket to support the rod during transportation between the vertical receiving position and the horizontal receiving position.

6. The rod handling assembly of claim 1 wherein the rod transport assembly comprises a linkage assembly adapted to move the rod between the vertical receiving position and the horizontal receiving position.

7. The rod handling system of claim 1 wherein the rod transfer assembly comprises a mounting plate having an opening to allow movement of the rod between the vertical receiving position and the rod string axis without threading the rod through the mounting plate.

8. A rod pushing and pulling machine for use with a rod string comprising a series of rod sections coupled to one another end to end, the rod string pushing and pulling machine comprising:
a housing including a front wall having an access opening therein through which the rod string extends from the housing;
a drive system supported by the housing for pushing and pulling the rod string along a rod string axis;
a rod handling assembly comprising:
a rod transfer assembly comprising a rod receiving member, wherein the rod receiving member comprises a gripper, and transports one of the series of rod sections between a horizontal receiving position and the rod string axis, wherein the rod transfer assembly comprises a frame along which the rod receiving member is movable independent of the rod handling assembly; and
a rod transport assembly operatively connected to the transfer assembly to transport the rod section when not connected to the rod string, between a vertical receiving position and the horizontal receiving position.

9. The rod pushing and pulling machine of claim 8 further comprising a platform positioned above the housing for use by an operator.

10. The rod pushing and pulling machine of claim 8 further comprising a remote control for use in controlling the function of the rod pushing and pulling machine and the rod handling assembly.

11. (canceled)

12. The rod pushing and pulling machine of claim 8 wherein the gripper is open on one side to position the rod in the horizontal receiving position without threading.

13. The rod pushing and pulling machine of claim 8 wherein the rod transport assembly comprises a socket to support the rod section during transport between the vertical receiving position and the horizontal receiving position.

14. The rod pushing and pulling machine of claim 13 wherein the rod transport assembly comprises a linkage adapted to move the socket between the vertical receiving position and the horizontal receiving position.

15. The rod pushing and pulling machine of claim 8 wherein the front wall has an opening to allow movement of the rod section between the vertical receiving position and the rod string axis without threading the rod through the front wall.

16. (canceled)

17. A method for adding rod sections to makeup a rod string comprised of a plurality of rod sections, using a rod pushing and pulling machine with a rod string axis and a rod handling assembly, the method comprising:
placing a rod section in a vertical receiving position within a rod handling assembly;
transporting the rod section from the vertical receiving position to a horizontal receiving position using a rod transport assembly; and
axially advancing the rod from the horizontal receiving position to the rod string axis with a rod transfer assembly.

18. The method of claim 17 wherein the method also comprising threading the rod to the rod string with a rotation assembly supported by the rod pushing and pulling machine.

19. The method of claim 18 further comprising advancing the rod string along the rod string axis after threading the rod section to the rod string.

20. A method for removing rod sections to breakup a rod string comprised of a plurality of rod sections, using a rod pushing and pulling machine with a rod string axis and a rod handling assembly, the method comprising:
axially retracting the rod string to position a rod section in a horizontal receiving position;
disconnecting the rod section from the rod string;
placing an end of the disconnected rod section in a rod transport assembly;
activating the rod handling assembly to transport the rod section to a vertical receiving position; and
removing the rod section from the rod handling assembly.

21. The method of claim 20 further comprising moving the rod handling assembly back to the horizontal receiving position.
